(19) United States
(12) Patent Application Publication
(10) Pub. No.: US 2003/0019741 A1
(43) Pub. Date: Jan. 30, 2003

(54) Method and apparatus for sealing a substrate surface during an electrochemical deposition process

(75) Inventors: Arnold V. Kholodenko, San Francisco, CA (US); Yan Rozenzon, Mountain View, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/912,578

(22) Filed: Jul. 24, 2001

(51) Int. Cl. C25D 17/00; C25D 17/04; B05C 3/00

(52) U.S. Cl. 204/224 R; 204/297.01; 118/400

(57) ABSTRACT

Apparatus for securing a substrate in an electrochemical deposition system are provided. In one aspect, an apparatus is provided for securing a substrate in an electrochemical deposition system having a contact ring for contacting a plating surface of the substrate, a thrust plate having an annular shoulder at least partially formed therein, the thrust plate adapted to move axially relative to the contact surface, and a flexible seal disposed on the thrust plate comprising a base portion for attaching to the annular shoulder of the thrust plate and a body portion extending outwardly from the base portion and defining a sealing surface for engaging a back surface of the substrate. The apparatus may be disposed in an electrochemical deposition system.

### BACKGROUND OF THE INVENTION

1. Field of the Invention

The invention generally relates to a method and apparatus for depositing a conductive material on a substrate disposed in an electrochemical deposition system.

2. Background of the Related Art

Sub-quarter micron, multi-level metallization is one of the key technologies for the next generation of ultra large-scale integration (ULSI). The multilevel interconnects that lie at the heart of this technology require planarization of interconnect features formed in high aspect ratio apertures, including contacts, vias, lines and other features. Reliable formation of these interconnect features is very important to the success of ULSI and to the continued effort to increase circuit density and quality on individual substrates and die.

As circuit densities increase, the widths of vias, contacts and other features decrease to less than 250 nanometers, whereas the thickness of the dielectric layers remains substantially constant, with the result that the aspect ratios for the features, i.e., their height divided by width, increases. Additionally, as the feature widths decrease, the device current remains constant or increases, which results in an increased current density in the feature. Many traditional deposition processes, such as physical vapor deposition (PVD) and chemical vapor deposition (CVD), have difficulty filling structures where the aspect ratio exceeds 4:1, and particularly where it exceeds 10:1. As a result of process limitations, electroplating, which had previously been limited to the fabrication of lines on circuit boards, is emerging as a new process of choice to fill vias and contacts on semiconductor devices.

Present designs of cells for electroplating a metal on a substrate are based on a fountain plater configuration. FIG. 1 is a cross sectional view of one embodiment of a typical fountain plater 10. Generally, the fountain plater 10 includes an electrolyte container 12 having a top opening, a substrate holder 14 disposed above the electrolyte container 12, an anode 16 disposed at a bottom portion of the electrolyte container 12, and a contact ring 20 contacting the substrate 22. A plurality of vacuum grooves 24 may be formed in the lower surface of the substrate holder 14. A vacuum pump (not shown) may be coupled to the substrate holder 14 in communication with the grooves 24 to create a vacuum condition capable of securing the substrate 22 to the substrate holder 14 during processing. An o-ring is disposed in an annular groove on the lower surface of the substrate holder 14 to provide a seal against the backside of a substrate disposed on the substrate holder.

The contact ring 20 comprises a plurality of metallic or semi-metallic contact pins 26 distributed about the peripheral portion of the substrate 22 to define a central substrate plating surface. The plurality of contact pins 26 extend radially inwardly over a narrow perimeter portion of the substrate 22 and contact a conductive seed layer of the substrate 22 at the tips of the contact pins 26. A power supply (not shown) is attached to the pins 26 thereby providing an electrical bias to the substrate 22. The substrate 22 is positioned above the cylindrical electrolyte container 12 and electrolyte flow impinges perpendicularly on the substrate plating surface during operation of the cell 10.

While present day electroplating cells, such as the one shown in FIG. 1, generally achieve acceptable filling of features on larger scale substrate features (i.e., features greater than 1 micron), a number of obstacles impair consistent reliable electroplating onto substrates having sub-micron-sized, high aspect ratio features. One particular obstacle involves providing uniform power distribution and current density across the substrate plating surface for uniform deposition of a metal layer having uniform thickness and. Another obstacle involves preventing unwanted edge and backside exposure to a plating fluid, e.g., electrolyte, to prevent contamination to a backside of a substrate being processed as well as subsequent substrates. A further obstacle involves providing sufficient force from a backside of the substrate to ensure proper contact between the substrate plating surface and the cathode contact member.

One attempt to improve uniform power distribution is by increasing the surface area of the contact pins to cover a larger portion of the substrate. However, high points on the substrate surface contact plating cell components, such as the substrate holder 14 and contact ring 20 shown in FIG. 1, can cause misalignment between contacts 26 of the contact ring 20 and the substrate leading to variations in current flow from pin to pin on each substrate. Because contact pins are typically made of a rigid material, such as copper plated stainless steel, platinum, or copper, the contact pins do not accommodate differentials on portions of the substrate. Thus, misalignment may cause failure of a seal between the substrate holder and the substrate at the perimeter of the substrate's backside. The elastic seal is critical to ensuring the vacuum condition and preventing electrolyte material from contacting the backside of the substrate.

Current technology employs the use of vacuum plates, such as the substrate holder 14 shown in FIG. 1, to form the backside seal. However, because of substrate misalignment and the inflexibility of the substrate holder 14 and the substrate 22 to adjust to the misalignment, a perfectly flush interface between the two components is difficult to achieve and may result in leakage of electrolyte to the backside of the substrate. Leaks compromise the vacuum and require constant pumping to maintain the substrate 22 secured against the substrate holder 14. The leaks and the inability to form a sufficient seal may also be exacerbated by the irregularities in hardware components such as between the substrate holder 14 and the contact pins 26.

As shown in FIG. 1, the contact pins 26 of the cell 10 only shield a small portion of the substrate surface area, the electrolyte is able to communicate with the backside of the substrate 22 and deposit thereon. Additionally, under present cell designs, deposited material and contaminants have been observed on the backside of a substrate 22 even when using o-rings to provide a seal against the backside of a substrate 22 disposed on the substrate holder 14. Backside plating requires post-plating cleaning of the substrates and apparatus to avoid contamination problems downstream and increases the cost of processing. Failure to remove materials or contaminants deposited on the o-ring, grooves 24, and backside of the substrate may result in particle formation and, if the electrolyte dries onto those components, damage to the substrate during separation of the substrate from the substrate holder.

Therefore, there remains a need for apparatus for delivering a uniform electrical power distribution to a substrate surface, maintaining a seal between a substrate and a processing apparatus, and preventing backside deposition.

### SUMMARY OF THE INVENTION

Aspects of the invention generally provide apparatus for forming and maintaining a seal with a substrate and thus, preventing deposition and contamination of surfaces of the substrate. In one aspect, an apparatus is provided for securing a substrate in an electrochemical deposition system including a contact surface for contacting a plating surface of the substrate, a thrust plate having an annular shoulder at least partially formed therein, the thrust plate adapted to move axially relative to the contact surface, and a flexible seal comprising a base portion for attaching to the annular shoulder of the thrust plate and a body portion extending outwardly from the base portion, the body portion defining a sealing surface for engaging a back surface of the substrate.

In another aspect, an apparatus is provided for securing a substrate in an electrochemical deposition system including an annular cathode contact ring having a contact surface for contacting a peripheral portion of a plating surface of the substrate, the contact ring comprising a first planar surface, an annular shoulder coupled to the first surface and a substrate support surface extending inwardly from the shoulder and supporting cathode contacts therein, the substrate support surface and shoulder defining a substrate receiving area, a thrust plate disposed opposite the annular cathode contact ring, the thrust plate having an annular shoulder formed therein, the thrust plate adapted to move axially relative to the contact surface, an annular flexible seal comprising a base portion for attaching the annular flexible seal to the annular shoulder of the thrust plate and a body portion extending outwardly from the base portion, the body portion defining a sealing surface extending radially outwardly of the base portion for engaging a back surface of the substrate.

In another aspect, an apparatus is provided for electroplating a substrate including a process kit comprising an electrolyte container, an electrode disposed at a first end of the process kit, a substrate holder assembly disposed within the cell body at a second end, the substrate holder including a contact surface for contacting a plating surface of the substrate, a thrust plate having an annular shoulder at least partially formed therein, the thrust plate adapted to move axially relative to the contact surface, and a flexible seal comprising a base portion for attaching to the annular shoulder of the thrust plate and a body portion extending outwardly from the base portion, the body portion defining a sealing surface for engaging a back surface of the substrate.

### BRIEF DESCRIPTION OF THE DRAWINGS

So that the manner in which the above recited aspects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a cross sectional view of one embodiment of a typical fountain plater 10 incorporating contact pins;

FIG. 2 is a cross sectional view of one embodiment of an electrochemical deposition system including a substrate holder having a flexible seal;

FIG. 3 is a cross sectional view of one embodiment of an electroplating process cell;

FIG. 4 is a partial cross sectional perspective view of one embodiment of a cathode contact ring;

FIG. 5A is a cross sectional view of one embodiment of a substrate assembly;

FIG. 5B is an enlarged perspective view of the flexible seal of FIG. 5A;

FIG. 5C is a cross sectional view of another embodiment of a substrate assembly;

FIG. 6 is an enlarged cross sectional view of the flexible seal of FIG. 5A;

FIG. 7A is an enlarged cross sectional view of another embodiment of a flexible seal;

FIG. 7B is an enlarged cross sectional view of the flexible seal of FIG. 7A contacting a substrate; and

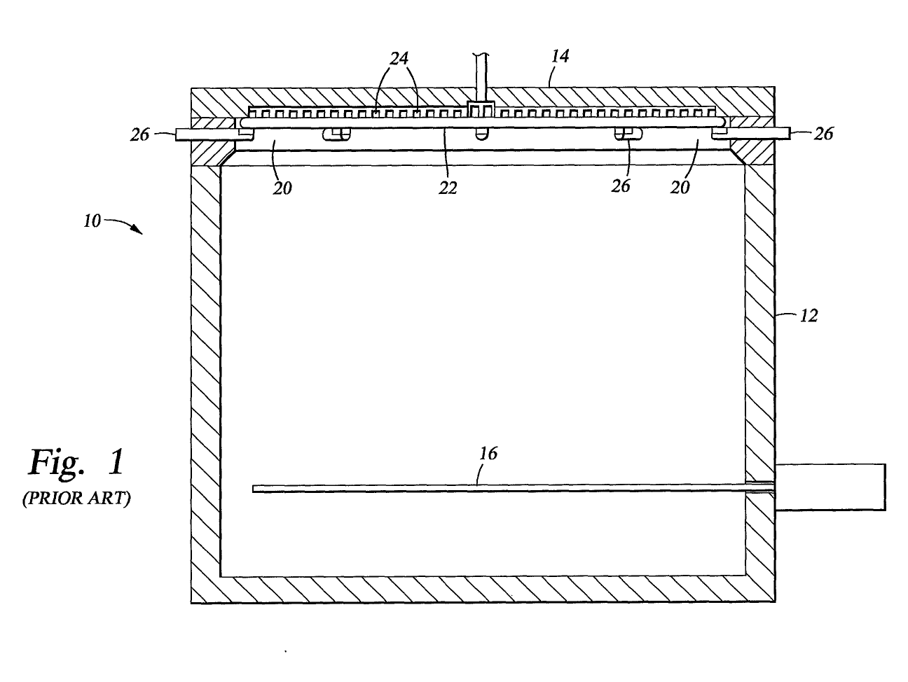

### DETAILED DESCRIPTION OF THE PREFERRED EMBODIMENT

Aspects of the invention generally provide apparatus for maintaining a uniform and repeatable contact resistance when delivering a uniform electrical power distribution to a substrate surface in an electroplating cell, maintaining a stable and constant vacuum or pressure condition between the substrate holder and the substrate, and preventing backside deposition by using a substrate holder having a flexible seal.

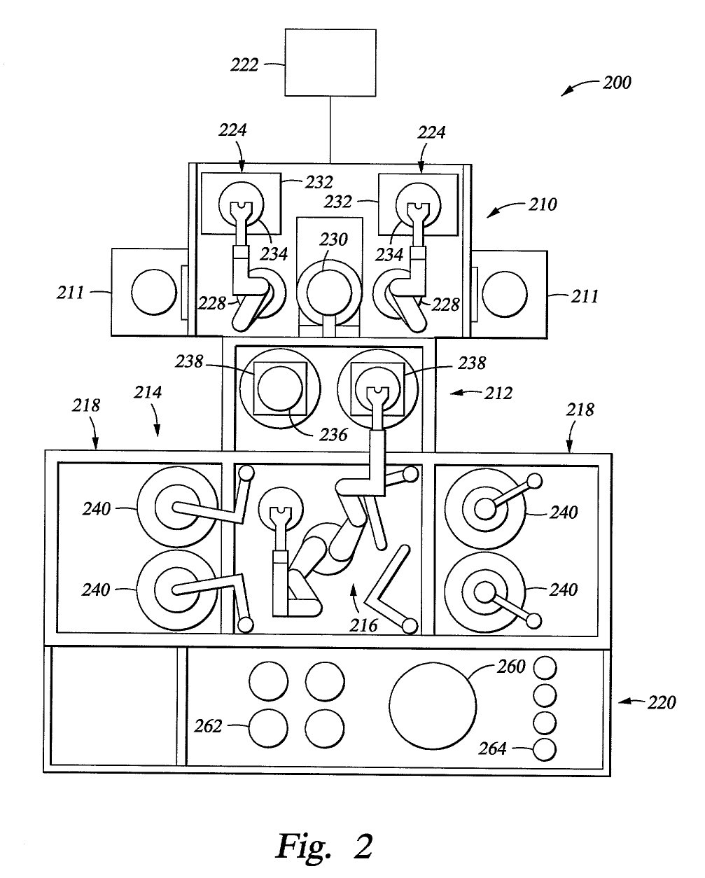

FIG. 2 is a schematic view of an electrochemical deposition system including a substrate holder having a flexible seal of the invention. The electrochemical deposition system 200 generally comprises a loading station 210, a thermal anneal chamber 211, a spin-rinse-dry (SRD) station 212, a mainframe 214, and an electrolyte replenishing system 220. Preferably, the electrochemical deposition system 200 is enclosed in a clean environment using panels such as Plexiglas panels. The mainframe 214 generally comprises a mainframe transfer station 216 and a plurality of processing stations 218. Each processing station 218 includes one or more electrochemical processing cells 240.

The loading station 210 preferably includes one or more substrate cassette receiving areas 224, one or more loading station transfer robots 228 and at least one substrate orientor 230. A substrate cassette 232 containing substrates 234 is loaded onto the substrate cassette receiving area 224 to introduce substrates 234 into the electrochemical deposition system 200. The SRD station 212 includes one or more SRD modules 236 and one or more substrate pass-through cassettes 238. The substrate pass-through cassette 238 provides access to and from both the loading station transfer robot 228 and a robot in the mainframe transfer station 216.

An electrolyte replenishing system 220 including a main electrolyte tank 260, a plurality of source tanks 262, and a plurality of filter tanks 264 is positioned adjacent the electrochemical deposition system 200 and connected to the process cells 240 individually to circulate electrolyte used for the electroplating process. The electrochemical deposition system 200 also includes a control system 222, typically comprising a programmable microprocessor.

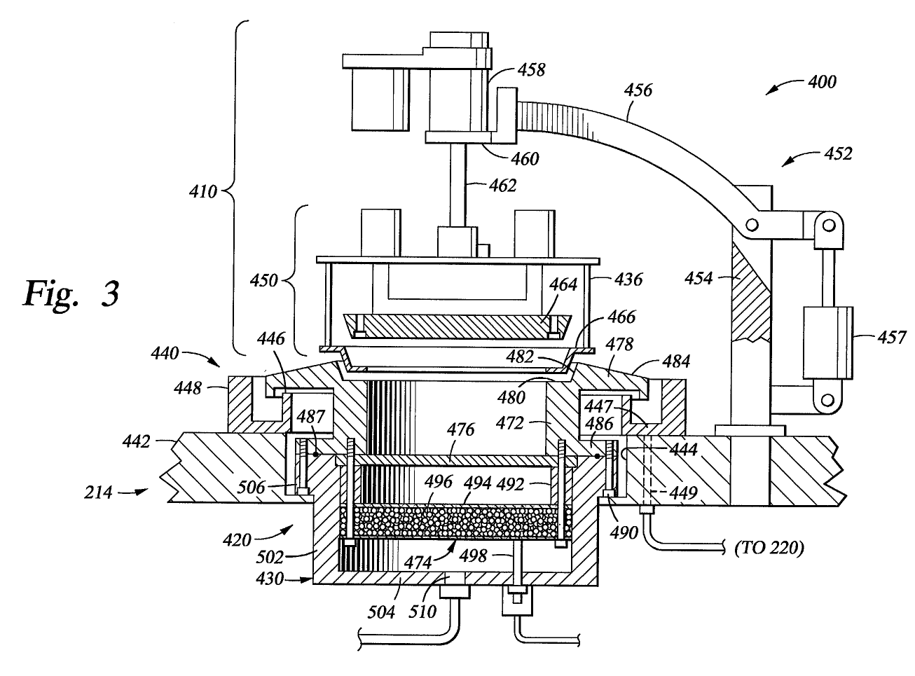

FIG. 3 is a cross sectional view of one embodiment of an electroplating process cell 400, which may be used as the electrochemical processing cell 240 as shown in FIG. 2. The processing cell 400 generally comprises a head assembly 410, a process kit 420 and an electrolyte collector 440.

The electrolyte collector 440 may be secured onto the base 442 over an opening 444 that defines the location for placement of the process kit 420. The electrolyte collector 440 includes an inner wall 446, an outer wall 448 and a bottom 447 connecting the walls 447, 448. An electrolyte outlet 449 is disposed through the bottom 447 of the electrolyte collector 440 and connected to an electrolyte replenishing system 220 through tubes, hoses, pipes or other fluid transfer connectors.

The head assembly 410 generally comprises a substrate holder assembly 450 and a substrate assembly actuator 458. The substrate assembly actuator 458 is mounted onto the mounting plate 460, and includes a head assembly shaft 462 extending downwardly through the mounting plate 460. The lower end of the head assembly shaft 462 is connected to the substrate holder assembly 450 to position the substrate holder assembly 450 in a processing position and in a substrate loading position.

The substrate holder assembly 450 is positioned above the process kit 420. The process kit 420 generally comprises a bowl 430, a container body 472, an anode assembly 474 and a filter 476. Preferably, the anode assembly 474 is disposed below the container body 472 and attached to a lower portion of the container body 472, and the filter 476 is disposed between the anode assembly 474 and the container body 472.

An upper portion of the container body 472 extends radially outwardly to form an annular weir 478. The upper surface of the weir 478 preferably matches the lower surface of the cathode contact ring 466. Preferably, the upper surface of the weir 478 includes an inner annular flat portion 480, a middle inclined portion 482 and an outer declined portion 484. The weir 478 extends over the inner wall 446 of the electrolyte collector 440 and allows the electrolyte to flow into the electrolyte collector 440. A lower portion of the container body 472 extends radially outwardly to form a lower annular flange 486 for securing the container body 472 to the bowl 430. The outer dimension (i.e., circumference) of the annular flange 486 is smaller than the dimensions of the opening 444 and the inner circumference of the electrolyte collector 440 to allow removal and replacement of the process kit 420 from the electroplating process cell 400.

The filter 476 is attached to and completely covers the lower opening of the container body 472, and the anode assembly 474 is disposed below the filter 476. A spacer 492 is disposed between the filter 476 and the anode assembly 474. The anode assembly 474 preferably comprises a consumable anode that serves as a metal source in the electrolyte or a non-consumable anode, and the metal to be electroplated is supplied within the electrolyte from the electrolyte replenishing system 220. As shown in FIG. 3, the anode assembly 474 is a self-enclosed module having a porous anode enclosure 494 preferably made of the same metal as the metal to be electroplated, such as copper. A soluble metal 496, such as high purity copper for electrochemical deposition of copper, is disposed within the anode enclosure 494.

An anode electrode contact 498 is inserted through the anode enclosure 494 to provide electrical connection to the soluble metal 496 from a power supply. The anode electrode contact 498 is made from a conductive material that is insoluble in the electrolyte, such as titanium, platinum and platinum-coated stainless steel. The anode electrode contact 498 extends through the bowl 430 and is connected to an electrical power supply.

The bowl 430 generally comprises a cylindrical portion 502 and a bottom portion 504. An upper annular flange 506 extends radially outwardly from the top of the cylindrical portion 502. The inner circumference of the cylindrical portion 502 accommodates the anode assembly 474 and the filter 476. Preferably, the outer dimensions of the filter 476 and the anode assembly 474 are slightly smaller than the inner dimension of the cylindrical portion 502 to force a substantial portion of the electrolyte to flow through the anode assembly 474 first before flowing through the filter 476. The bottom portion 504 of the bowl 430 includes an electrolyte inlet 510 that connects to an electrolyte supply line from the electrolyte replenishing system 220.

The head assembly 410 is mounted onto a head assembly frame 452. The head assembly frame 452 includes a mounting post 454 and a cantilever arm 456. The mounting post 454 is mounted onto the base 442 of the electroplating process cell 400, and the cantilever arm 456 extends laterally from an upper portion of the mounting post 454. Preferably, the mounting post 454 provides rotational movement with respect to a vertical axis along the mounting post to allow rotation of the head assembly 410.

The head assembly 410 is attached to a mounting plate 460 disposed at the distal end of the cantilever arm 456. The lower end of the cantilever arm 456 is connected to a cantilever arm actuator 457, such as a pneumatic cylinder, mounted on the mounting post 454. The cantilever arm actuator 457 provides pivotal movement of the cantilever arm 456 with respect to the joint between the cantilever arm 456 and the mounting post 454.

The substrate assembly actuator 458 may be configured to provide rotary motion to the head assembly 410. The rotation of the substrate during the electroplating process generally enhances the deposition results. The head assembly 410 may be rotated between about 2 rpm and about 20 rpm during the electroplating process and may be rotated at a high speed (i.e., >20 rpm) when the head assembly 410 is lifted from the process cell.

The substrate holder assembly 450 generally comprises a thrust plate 464 and a cathode contact ring 466 that are suspended from a hanger plate 436. The hanger plate 436 is coupled to the head assembly shaft 462. The cathode contact ring 466 is coupled to the hanger plate by hanger pins. The hanger pins allows the cathode contact ring 466 when mated with the weir 478, to move to closer to the hanger plate 436, thus allowing the substrate held by the thrust plate 464 to be sandwiched between the hanger plate 436 and thrust plate 464 for processing.

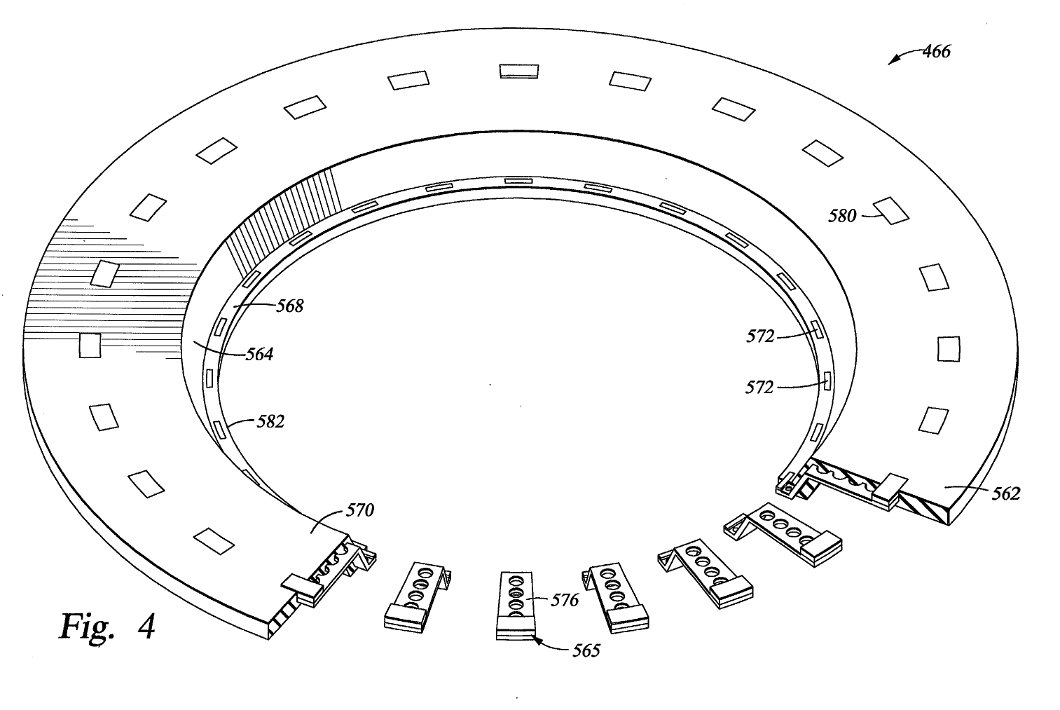

FIG. 4 is a cross sectional view of one embodiment of a cathode contact ring 466 of the present invention. In general, the contact ring 466 comprises an annular body having a plurality of conducting members disposed thereon. The annular body is constructed of an insulating material to electrically isolate the plurality of conducting members. Together the body and conducting members form a diametrically interior substrate seating surface which, during processing, supports a substrate and provides a current thereto.

Referring now to FIG. 4 in detail, the contact ring 466 generally comprises a plurality of conducting members 565 at least partially disposed within an annular insulative body 570. The insulative body 570 is shown having a flange 562 and a downward sloping shoulder portion 564 leading to a substrate seating surface 568 located below the flange 562 such that the flange 562 and the substrate seating surface 568 lie in offset and substantially parallel planes. In another embodiment, the shoulder portion 564 may be of a steeper angle including a substantially vertical angle so as to be substantially normal to both the flange 562 and the substrate seating surface 568. Alternatively, the contact ring 466 may be substantially planar thereby eliminating the shoulder portion 564.

The insulative body 570 generally comprises a ceramic, plastic, or other substantailly rgid, electrically insulating material. The insulative body 570 material may include a plastic such as polyvinylidenefluoride (PVDF), perfluoroalkoxy resin (PFA), fluoropolymers, such as Teflon™ and Tefzel™, Alumina (Al₂O₃) or other ceramics, and similar insulating materials.

The conducting members 565 are defined by a plurality of outer electrical contact pads 580 annularly disposed on the flange 562, a plurality of inner electrical contact pads 572 disposed on a portion of the substrate seating surface 568, and a plurality of embedded conducting connectors 576 which link the pads 572, 580 to one another. The conducting members 565 are isolated from one another by the insulative body 570. The outer contact pads 580 are coupled to a power supply (not shown) to deliver current and voltage to the inner contact pads 572 via the connectors 576 during processing. The inner contact pads 572 supply the current and voltage to a substrate by maintaining contact around a peripheral portion of the substrate. Thus, in operation the conducting members 565 act as discrete current paths electrically connected to a substrate.

The conducting members typically comprise a low resistivity, and conversely high conductivity, material including copper (Cu), platinum (Pt), tantalum (Ta), titanium (Ti), gold (Au), silver (Ag), stainless steel or other conducting materials. Alternatively, the conducting members 265 may be coated with a low resistivity and low contact resistance conducting material. For example, conducting members 565 may comprise copper coated with platinum. Suitable coating materials include tantalum nitride (TaN), titanium nitride (TiN), rhodium (Rh), gold (Au), copper (Cu), silver (Ag), or combinations thereof, on a conductive base material, which may include stainless steel, molybdenum (Mo), copper (Cu), titanium (Ti), and combinations thereof. The inner contact pads 572 generally comprise a material resistant to oxidation from the electrolyte, for example, Pt, Ag, or Au. Further, since the contact pads 572, 580 are typically separate units bonded to the conducting connectors 576, the contact pads 572, 580 may each be the same or different material, for example, copper, and the conducting members 565 another may each be the same or different material, for example, stainless steel. Either or both of the pads 572, 780 and conducting connectors 576 may be coated with a conducting material.

In addition to being a function of the contact material, the total resistance of each circuit is dependent on the geometry, or shape, of the inner contact inner contact pads 572 and the force supplied by the contact ring 466. These factors define a constriction resistance, R_{CR}, at the interface of the inner contact pads 572 and the substrate seating surface 568 due to asperities between the two surfaces. Generally, as the applied force is increased the apparent area is also increased. The apparent area is, in turn, inversely related to R_{CR} so that an increase in the apparent area results in a decreased R_{CR}. Thus, to minimize overall resistance it is preferable to maximize force. The maximum force applied in operation is limited by the yield strength of a substrate that may be damaged under excessive force and resulting pressure.

However, because pressure is related to both force and area, the maximum sustainable force is also dependent on the geometry of the inner contact pads 572. Thus, while the contact pads 572 may have a flat upper surface as in FIG. 4, the invention contemplates the used of other shapes, such as a knife-edge contact pad and a hemispherical contact pad. A person skilled in the art will readily recognize other shapes that may be used to advantage. A more complete discussion of the relation between contact geometry, force, and resistance is given in Ney Contact Manual, by Kenneth E. Pitney, The J. M. Ney Company, 1973, which is hereby incorporated by reference in its entirety.

The number of connectors 576 may be varied depending on the particular number of contact pads 572 (shown in FIG. 4) desired. For example, a contact ring for a 200 mm substrate may include between twenty-four and thirty-six connectors 576 spaced equally over 360°. However, the number of connectors may be varied on the use and application of the contact ring, for example, a single contact pad 272 which may circumscribe the contact ring 466 may be used. Since the dimensions of the present invention are readily altered to suit a particular application (for example, a 300 mm substrate), the number may easily be modified for varying scales and embodiments.

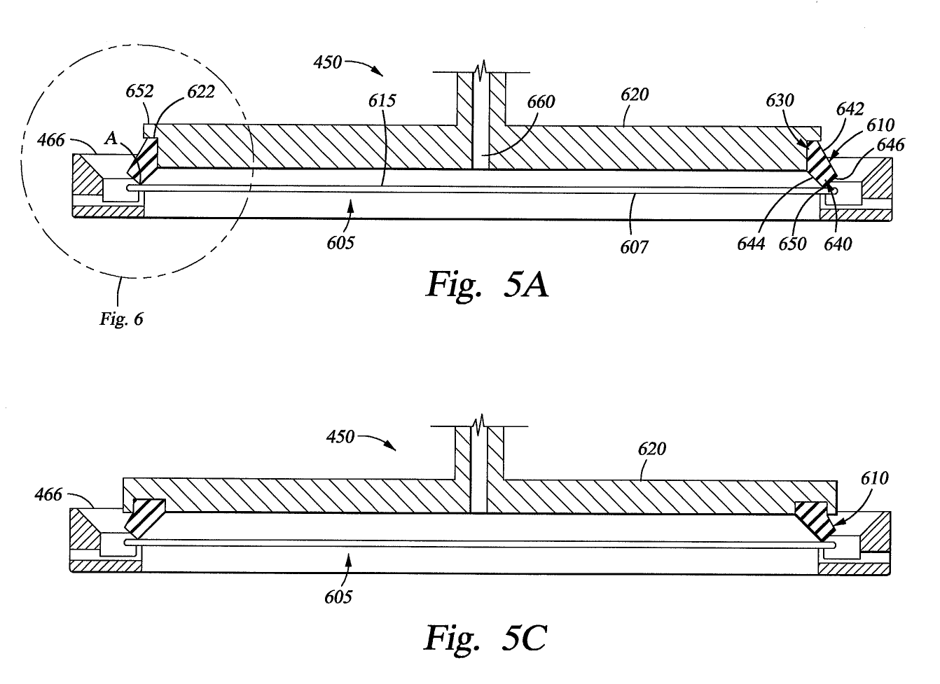

Referring to FIGS. 5A and 5B, one embodiment of the substrate holder assembly 450 is positioned with the cathode contact ring 466. The substrate holder assembly 450 comprises a flexible seal assembly including a flexible seal 610 disposed on a thrust plate 620. The flexible seal assembly provides pressure to the backside of a substrate and ensures electrical contact between the substrate plating surface and the cathode contact ring 466. In the embodiment shown in FIG. 5A, the flexible seal 610 is circumferentially disposed around a peripheral portion of the thrust plate 620.

The thrust plate 620 may include a peripheral groove or shoulder 622, and the flexible seal 610 may be stretched and placed on the peripheral shoulder. The elasticity of the flexible seal 610 maintains the position of the flexible seal 610 on the thrust plate 620. Alternatively, retaining ridges may be disposed on the edges of the peripheral shoulder 622 to maintain the position of the flexible seal on the thrust plate 620. As a further alternative, the thrust plate may include a circumferential groove disposed within the outer diameter 652 of the thrust plate 620, and the flexible seal 610 may be disposed in the circumferential groove as shown in FIG. 5C.

The thrust plate 620 shown in FIG. 5A is substantially disc-shaped having a peripheral shoulder 622 formed on a lower peripheral surface and a centrally disposed vacuum port 660. The flexible seal 610 includes a base portion 630 and a body portion 640. The base portion 630 includes a vertical surface 632 and a horizontal surface 634 disposed against surfaces of the peripheral shoulder 622. The body portion 640 extends radially outwardly from the base portion 630 of the flexible seal 610.

In one embodiment, the body portion 640 extends from the base portion 630. The body portion 640 defines an upper surface 642, an inner lower surface 644, and an outer lower surface 646. The inner lower surface 644 has a frustoconical shape that extends radially outwardly from the vertical surface 632 in a first direction. The upper surface 642 has a frustoconical shape that extends radially outwardly from the horizontal surface 634 in a second direction. The outer lower surface 646 connects between the upper surface 642 and the inner lower surface 644. The intersection of the inner lower surface 644 and the outer lower surface 646 forms a sealing surface 650 of the flexible seal 610. The sealing surface 650 contacts the substrate 605 at a point A (as shown in FIGS. 5A and 10) to form an annular seal around the periphery of the backside of the substrate 605.

In one embodiment, the sealing surface 650 is disposed radially outwardly of the base portion 630 (i.e., the diameter of the sealing surface 650 is greater than the maximum diameter of the horizontal surface 634). The inner and outer lower surfaces 644, 646 define frustoconical surfaces with respect to the substrate back surface.

In the embodiment shown in FIG. 5A, the vertical surface 632 forms an elastic contact around a cylindrical portion of the peripheral shoulder 622 of the thrust plate 620. The horizontal surface 634 is an annular surface that engages a lower surface of the peripheral shoulder 622 of the thrust plate 620. Thus, the thrust plate 620 may provide a force in an axial direction that is substantially perpendicular to the back surface of the substrate.

The flexible seal 610 is fabricated from a fluid impervious material, such as an elastomer, that is corrosion resistant and/or chemically inert with respect to electrochemical deposition fluids, such as electrolytes, resistant to fluid diffusion, and/or exhibits reliable elasticity without substantial permanent deformation of the material. The exposed surfaces of the flexible seal 610 may be coated or treated to provide a hydrophilic surface to promote dripping and removal of the residual electrolyte after the head assembly is lifted above the process cell.

The flexible seal material generally has a durometer hardness that effectively seals against the substrate without stressing or damaging the substrate, for example, a durometer hardness between about 60 and about 80. A material having a durometer hardness between about 65 and about 75 may be used as the flexible seal material. The flexible seal material generally has breaking elongation of between about 100% and about 150%. The material of the flexible seal 620 also generally has an extent of stretching between 20% and about 40% of the breaking elongation of the material. An example of such a material is an ethylene-propylene terpolymer (EPDM) based upon stereospecific linear terpolymers of propylene, ethylene, and small amounts of non-conjugated diene, of which the polymer may be vulcanized with sulfur. Other materials that may be used for the flexible seal 610 include Viton™. However, the invention contemplates the use of additional material having the properties described herein and contemplates that the seal material selection may be change by the operator based on the chemical environment to which the seal is exposed.

The vacuum port 660 may be attached to a vacuum/pressure pumping system (not shown) adapted to selectively supply a pressure or create a vacuum at a backside of the substrate 605. However, the invention contemplates processing substrates without the need for a vacuum port to help secure and process a substrate.

The pumping system typically includes a pump, a cross-over valve, and a vacuum ejector (commonly known as a venturi). One vacuum ejector that may be used to advantage in the present invention is available from SMC Pneumatics, Inc., of Indianapolis, Ind. The vacuum/pressure pump is coupled to one end of a hose (not shown) and the other end of the hose is coupled to the vacuum port 660.

Fluid flow is controlled by the cross-over valve that selectively switches communication with the pump between supplying a pressure and a vacuum. Additionally the pump may have an OFF setting whereby fluid is restricted from flowing in either direction through the hose. A shut-off valve disposed in the hose prevents fluid from flowing from the pressure line upstream through the vacuum ejector. Alternatively, a separate gas supply and vacuum pump may supply the backside pressure and vacuum conditions.

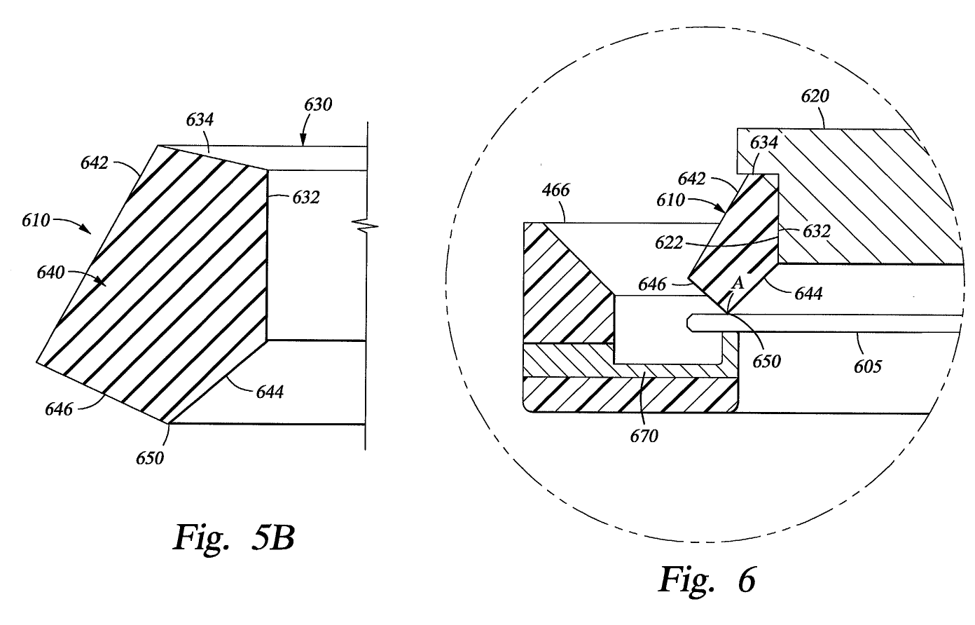

FIG. 6 is a more detailed cross section view of the flexible seal 610 of FIG. 5A disposed in contact with a back surface of a substrate. The flexible seal 610 is in an compressed and stresses state and thus deformed slightly to the flexible seal as shown in FIG. 5B, which is in an unstressed and uncompressed state. In operation, the substrate 605 is introduced into the substrate holder assembly 450 by securing the substrate 605 to the lower side of the thrust plate 620. This is accomplished by engaging the pumping system to evacuate the space between the substrate 605 and the thrust plate 620 via port 660, thereby creating a vacuum condition.

The thrust plate 620 and substrate 605 are then lowered into contact with the contact ring 466. As the seal 610 is pressed against the substrate back surface, the sealing surface 650 of the inner and outer lower surfaces 644, 646 contacts the substrate back surface. A seating stress between about 150 psi and about 400 psi may be applied in a vertical direction when contacting the backside of the substrate 605 with the flexible seal 610. The flexible seal 620 is then stretched radially along the substrate surface while compressed axially against the backside of the substrate 605 to form an annular seal along the periphery of the backside of the substrate. The backside 615 of the substrate 605 is isolated from contact with the polishing fluid 130 and backside contamination is substantially eliminated. Also, because the sealing surface 650 is disposed radially outwardly of the base portion 610, the sealing surface 650 expands radially outwardly as the sealing surface 650 is pressed against the substrate back surface. The thrust plate 620 and flexible seal 610 may be configured to provide a seal above the contacts 670, such as shown at point A, to press the substrate 605 uniformly against the contacts of the cathode contact ring 466.

The electroplating process may then be performed on the substrate disposed on the cathode ring. An electrolyte is then pumped into the process kit 420 toward the substrate 605 to contact the exposed substrate plating surface 607. The power supply provides a negative bias to the substrate plating surface 607 via the cathode contact ring 466. As the electrolyte is flowed across the substrate plating surface 607, ions in the electrolytic solution are attracted to the surface 607 and deposit on the surface 607 to form the desired film.

As the thrust plate 620 is moved away from the substrate, the pressure on the sealing surface 650 is reduced and the sealing surface 650 contracts radially inwardly to an uncompressed state. The force used for the downward compression and radially outward displacement of the seal against the backside of the substrate assists in releasing the substrate from the contact ring by contracting the seal to minimize any material adhesion between the substrate and seal. Thus, the flexible seal 610 may serve to seal the substrate back surface from electrochemical processing fluids while providing effective separation from the substrate back surface when desired.

The flexible seal 610 also deforms to accommodate any irregular aspects in the backside of the substrate which may compromise the seal and allow fluid to contact the backside of the substrate while retaining a hermetic seal. The flexible seal 610 prevents the electrolyte from contaminating the backside of the substrate 605 by establishing a fluid tight seal at a perimeter of the backside 615 of the substrate 605. Once a uniform pressure is delivered downward toward the cathode contact ring 466, the sealing surface 650 achieves a substantially equal force at all points where the substrate 605 and cathode contact ring 466 interface. Further, the effectiveness of the flexible seal assembly is not dependent on the configuration of the cathode contact ring 466. Because the force delivered to the substrate 605 by the flexible seal 610 may be varied, adjustments can be made to the current flow supplied by the contact ring 466.

Additionally, the fluid tight seal provided by the flexible seal 610 allows a pump to maintain a backside vacuum or pressure either selectively or continuously, before, during, and after processing. A continuous backside vacuum pumping while the flexible seal 610 is contacting the backside 615 of the substrate 605 minimizes contamination of materials by increasing the force between the seal 610 and substrate 605. Additionally, the seal 610 can retain a heremetic seal with the backside of the substrate when a backpressure is provided to the backside of the substrate to cause a “bowing” effect of the substrate to be processed. Backpressure to cause “bowing” may be used in processing since “bowing” of the substrate during processing results in superior deposition on the plating surface of a substrate. Thus, pumping system is capable of selectively providing a vacuum or pressure condition to the substrate backside. For a 200 mm substrate a backside pressure up to 5 psi is preferable to bow the substrate. Because substrates typically exhibit some measure of pliability, a backside pressure causes the substrate to bow or assume a convex shape relative to the upward flow of the electrolyte. The degree of bowing is variable according to the pressure supplied by pumping system.

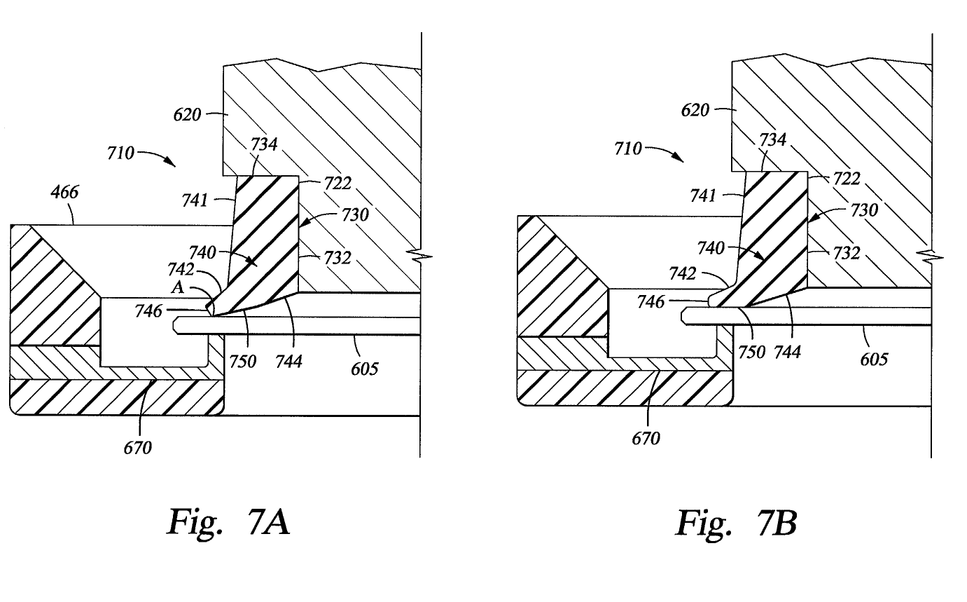

FIGS. 7A and 7B illustrate another embodiment of a flexible seal. The flexible seal 710 includes a base portion 730 and a body portion 740. The base portion 730 includes a vertical surface 732 and a horizontal surface 734 disposed against surfaces of the peripheral indentation, or shoulder 722. The vertical surface 732 forms an elastic contact around a cylindrical portion of the shoulder 722 of the thrust plate 720. The horizontal surface 734 is an annular surface that engages a lower surface of the shoulder 722 of the thrust plate 720. The thrust plate 720 may provide a force in an axial direction that is substantially perpendicular to the back surface of the substrate.

The body portion 740 extends radially outwardly from the base portion 730 of the flexible seal 710. In one embodiment, the body portion 740 has frustoconical shape that extends in a first direction from the base portion 730. The body portion 640 defines a first seal surface including an outer upper surface 741, an outer flexing surface 742, an outer lower surface 746, a second seal surface including an inner lower surface 744, and a contacting surface 750. The inner lower surface 744 has frustoconical shape that extends radially outwardly from the vertical surface 732 in a first direction with the substrate surface. The contacting surface 750 has frustoconical shape that extends radially outwardly from the inner lower surface 744 at a second direction in relation to the substrate surface.

The outer upper surface 741 extends radially outwardly from the horizontal surface 734 in a first. The outer flexing surface 742 has frustoconical shape that extends radially outwardly from the outer upper surface 741 at a second direction in relation to the substrate surface. The outer lower surface 746 connects between the outer flexing surface 742 and the sealing surface 750.

The sealing surface 750 initially contacts the substrate 605 at a point A but then deforms under pressure from the thrust plate 720 to provide substantial annular contact along the sealing surface 750 and back of substrate. The substantial annular contact forms an annular seal around the periphery of the backside of the substrate 605. In one embodiment, the sealing surface 750 is disposed radially outwardly of the base portion 730 (i.e., the diameter of the sealing surface 750 is greater than the maximum diameter of the horizontal surface 734). The flexible seal 710 is fabricated of the same material as disclosed for seal 610.

FIG. 7B is a cross section view of the flexible seal of FIG. 7A disposed in contact with a back surface of a substrate. In operation, the thrust plate 720 holding a substrate 605 is lowered into contact with the backside of the substrate 605. As the flexible seal 710 is pressed against the substrate back surface, the sealing surface 750 contacts the substrate back surface at point A. The flexible seal deforms at a position between the outer upper surface 741 and flexible surface 742 and sealing surface 750 is then stretched radially along the substrate surface while being compressed axially against the backside of the substrate 605 to form an annular seal along the periphery of the backside of the substrate.

The following is a description of a typical substrate electroplating process sequence through the electroplating system platform 200 as shown in FIG. 2. A substrate cassette containing a plurality of substrates is loaded into the substrate cassette receiving areas 224 in the loading station 210 of the electroplating system platform 200. A loading station transfer robot 228 picks up a substrate from a substrate slot in the substrate cassette and places the substrate in the substrate orientor 230. The substrate orientor 230 determines and orients the substrate to a desired orientation for processing through the system. The loading station transfer robot 228 then transfers the oriented substrate from the substrate orientor 230 and positions the substrate in one of the substrate slots in the substrate pass-through cassette 238 in the SRD station 212. The mainframe transfer robot 216 picks up the substrate from the substrate pass-through cassette 238 and positions the substrate for transfer by the flipper robot 248.

The flipper robot 248 rotates its robot blade below the substrate and picks up substrate from mainframe transfer robot blade. The vacuum suction gripper on the flipper robot blade secures the substrate on the flipper robot blade, and the flipper robot flips the substrate from a face up position to a face down position. The flipper robot 248 rotates and positions the substrate face down in the substrate holder assembly 450. The substrate is positioned below the substrate holder 464 but above the cathode contact ring 466. The flipper robot 248 then releases the substrate to position the substrate into the cathode contact ring 466. The substrate holder 464 moves toward the substrate and the vacuum chuck secures the substrate on the substrate holder 464.

The flexible seal assembly on the substrate holder assembly 450 exerts pressure against the substrate backside to ensure electrical contact between the substrate plating surface and the cathode contact ring 466. The flexible seal 610 is pressed against the substrate back surface contacting the sealing surface 650 with the substrate back surface to form a seal. The flexible seal 620 is then stretched radially along the substrate surface while compressed axially against the backside of the substrate to form an annular seal along the periphery of the backside of the substrate.

The head assembly 452 is lowered to a processing position above the process kit 420. At this position the substrate is below the upper plane of the weir 478 and contacts the electrolyte contained in the process kit 420. The power supply is activated to supply electrical power (i.e., voltage and current) to the cathode and the anode to enable the electroplating process. The electrolyte is typically continually pumped into the process kit during the electroplating process. The electrical power supplied to the cathode and the anode and the flow of the electrolyte are controlled by the control system 222 to achieve the desired electroplating results. Preferably, the head assembly is rotated as the head assembly is lowered and also during the electroplating process.

After the electroplating process is completed, the head assembly 410 raises the substrate holder assembly and removes the substrate from the electrolyte. The head assembly may be rotated for a period of time to enhance removal of residual electrolyte from the substrate holder assembly. As the head assembly 410 is moved away from the substrate, the pressure on the sealing surface 650 is reduced and the sealing surface 650 contracts radially inwardly to an uncompressed state. The force used for the downward compression and radially outward displacement of the seal against the backside of the substrate assists in releasing the substrate from the contact ring by contracting the seal to minimizes any material adhesion between the substrate and seal. If the vacuum chuck if used, the vacuum chuck then releases the substrate from the substrate holder.

The substrate holder is raised to allow the flipper robot blade to pick up the processed substrate from the cathode contact ring. The flipper robot rotates the flipper robot blade above the backside of the processed substrate in the cathode contact ring and picks up the substrate using the vacuum suction gripper on the flipper robot blade. The flipper robot rotates the flipper robot blade with the substrate out of the substrate holder assembly, flips the substrate from a face-down position to a face-up position, and positions the substrate on the mainframe transfer robot blade.

The mainframe transfer robot then transfers and positions the processed substrate above the SRD module 236. The SRD substrate support lifts the substrate, and the mainframe transfer robot blade retracts away from the SRD module 236. The substrate is cleaned in the SRD module using deionized water or a combination of deionized water and a cleaning fluid as described in detail above. The substrate is then positioned for transfer out of the SRD module.

The loading station transfer robot 228 picks up the substrate from the SRD module 236 and transfers the processed substrate into the RTA chamber 211 for an anneal treatment process to enhance the properties of the deposited materials. The annealed substrate is then transferred out of the RTA chamber 211 by the loading station robot 228 and placed back into the substrate cassette for removal from the electroplating system. The above-described sequence can be carried out for a plurality of substrates substantially simultaneously in the electroplating system platform 200 of the present invention. Also, the electroplating system according to the invention can be adapted to provide multi-stack substrate processing.

While the foregoing is directed to the preferred embodiment of the present invention, other and further embodiments of the invention may be devised without departing from the basic scope thereof, and the scope thereof is determined by the claims that follow.

What is claimed is:

1. An apparatus for securing a substrate in an electrochemical deposition system, comprising:
a contact surface for contacting a plating surface of the substrate;
a thrust plate having an annular shoulder at least partially formed therein, the thrust plate adapted to move axially relative to the contact surface; and
a flexible seal comprising:
a base portion for attaching to the annular shoulder of the thrust plate; and
a body portion extending outwardly from the base portion, the body defining a sealing surface for engaging a back surface of the substrate.

2. The apparatus of claim 1, wherein the sealing surface extends radially outwardly of the base portion.

3. The apparatus of claim 2, wherein the body portion comprises first and second seal surfaces of intersecting frustoconical surfaces, wherein the intersecting frustoconical surfaces form the sealing surface.

4. The apparatus of claim 3, wherein the first and second seal surfaces are stretched radially and compressed axially to form a hermetic seal when the sealing surface contacts the backside of the substrate.

5. The apparatus of claim 1, wherein the contact surface comprises cathode contacts disposed on an annular electrical contact ring having a substrate sealing surface disposed opposite the thrusting plate.

6. The apparatus claim 1, wherein the body portion comprises a flexible material chemically inert to an electrolyte solution and resistant to fluid diffusion.

7. The apparatus claim 6, wherein the body portion comprises an elastomer.

8. The apparatus claim 1, wherein the sealing surface contacts the back surface of the substrate and forms an annular seal when the thrusting plate selectively biases the substrate to the sealing surface.

9. The apparatus of claim 5, wherein the substrate sealing surface disposed opposite the thrusting plate comprises:
a first planar surface;
an annular shoulder coupled to the first surface; and
a substrate support surface extending inwardly from the shoulder and supporting cathode contacts therein, the substrate support surface and shoulder defining a substrate receiving area.

10. An apparatus for securing a substrate in an electrochemical deposition system, comprising:
an annular cathode contact ring having a contact surface for contacting a peripheral portion of a plating surface of the substrate, the contact ring comprising:
a first planar surface;
an annular shoulder coupled to the first surface; and
a substrate support surface extending inwardly from the shoulder and supporting cathode contacts therein, the substrate support surface and shoulder defining a substrate receiving area;
a thrust plate disposed opposite the annular cathode contact ring, the thrust plate having an annular shoulder formed therein, the thrust plate adapted to move axially relative to the contact surface;
an annular flexible seal comprising:
a base portion for attaching the annular flexible seal to the annular shoulder of the thrust plate; and
a body portion extending outwardly from the base portion, the body portion defining a sealing surface extending radially outwardly of the base portion for engaging a back surface of the substrate.

11. The apparatus of claim 10, wherein the body portion comprises first and second seal surfaces of intersecting frustoconical surfaces, wherein the intersecting frustoconical surfaces form the sealing surface.

12. The apparatus of claim 10, wherein the annular flexible seal stretches radially and compresses axially to form a hermetic seal when the sealing surface contacts the backside of the substrate.

13. The apparatus claim 10, wherein the body portion comprises a flexible material chemically inert to an electrolyte solution and resistant to fluid diffusion.

14. The apparatus claim 11, wherein the sealing surface contacts the back surface of the substrate and forms an annular seal when the thrusting plate selectively biases the substrate to the sealing surface.

15. An apparatus for electroplating a substrate comprising:
a process kit comprising an electrolyte container;
an electrode disposed at a first end of the process kit;
a substrate holder assembly disposed within the cell body at a second end, the substrate holder comprising:
a contact surface for contacting a plating surface of the substrate;
a thrust plate having an annular shoulder at least partially formed therein, the thrust plate adapted to move axially relative to the contact surface; and
a flexible seal comprising:
a base portion for attaching to the annular shoulder of the thrust plate; and
a body portion extending outwardly from the base portion, the body portion defining a sealing surface for engaging a back surface of the substrate; and
one or more power supplies coupled to the electrode and the electrode contact ring.

16. The apparatus of claim 15, wherein the apparatus is disposed in an electrochemical deposition system, the electrochemical deposition system comprising:
a mainframe having one or more stations disposed therein for electrochemical depositing a material on the substrate;
a mainframe substrate transfer robot;
a loading station disposed in connection with the mainframe; and
an electrolyte supply fluidly connected to the mainframe.

17. The apparatus of claim 15, wherein the sealing surface extends radially outwardly of the base portion.

18. The apparatus of claim 17, wherein the body portion comprises first and second seal surfaces of intersecting frustoconical surfaces, wherein the intersecting frustoconical surfaces form the sealing surface.

19. The apparatus of claim 18, wherein the first and second seal surfaces are stretched radially and compressed axially to form a hermetic seal when the sealing surface contacts the backside of the substrate.

20. The apparatus of claim 15, wherein the contact surface comprises cathode contacts disposed on an annular electrical contact ring having a substrate sealing surface disposed opposite the thrusting plate.

21. The apparatus claim 15, wherein the body portion comprises a flexible material chemically inert to an electrolyte solution and resistant to fluid diffusion.

22. The apparatus claim 21, wherein the body portion comprises an elastomer.

23. The apparatus claim 15, wherein the sealing surface contacts the back surface of the substrate and forms an annular seal when the thrusting plate selectively biases the substrate to the sealing surface.

24. The apparatus of claim 23, wherein the substrate sealing surface disposed opposite the thrusting plate comprises:
a first planar surface;
an annular shoulder coupled to the first surface; and
a substrate support surface extending inwardly from the shoulder and supporting cathode contacts therein, the substrate support surface and shoulder defining a substrate receiving area.
